(19) United States
(12) Patent Application Publication
(10) Pub. No.: US 2007/0117883 A1
(43) Pub. Date: May 24, 2007

(54) Water base dispersion solution and water base ink composition

(75) Inventor: Akira Mizutani, Matsumoto-shi (JP)

Correspondence Address: LADAS & PARRY, 26 WEST 61ST STREET, NEW YORK, NY, 10023, US

(73) Assignee: SEIKO EPSON CORPORATION

(21) Appl. No.: 11/600,336

(22) Filed: Nov. 14, 2006

(30) Foreign Application Priority Data
Nov. 18, 2005 (JP) 2005-334026

(51) Int. Cl. C09D 11/00

(52) U.S. Cl. 523/160; 523/161

(57) ABSTRACT

A water base dispersion solution including hollow polymer microparticles, wherein the hollow polymer microparticles are composed of a plurality of microparticle subgroups, and the difference in the mean particle size between microparticle subgroups that are mutually adjacent in terms of mean particle size is less than 100 nm.

### CROSS-REFERENCE TO RELATED APPLICATIONS

The entire disclosure of Japanese Patent Application No. 2005-334026, filed on Nov. 18, 2005, is expressly incorporated by reference herein.

### BACKGROUND

1. Technical Field

The present invention relates to a water base dispersion solution and a water base ink composition. The water base dispersion solution of the present invention comprises hollow polymer microparticles, it is therefore useful for the preparation of white ink compositions. In particular, because hollow polymer microparticle subgroups having a plurality of mean particle sizes are combined in the water base dispersion solution, the solution is useful for the preparation of white ink compositions having a high hiding ability.

2. Related Art

Using hollow polymer microparticles as a white colorant in white ink compositions for ink jet recording is known (U.S. Pat. No. 4,880,465). The hollow polymer microparticles described in U.S. Pat. No. 4,880,465 are spheres with an outer size of 1 μm or less that have a central cavity in each microparticle and consist of a liquid-permeable polymer membrane. Therefore, when such particles are present in an aqueous ink composition, the central cavities are filled with an aqueous medium. Because the hollow polymer microparticles filled with an aqueous medium have a specific gravity close to that of the aqueous medium, the settling problem associated with inorganic pigments can be effectively resolved and shelf life and jetting stability of ink composition are improved. Furthermore, if the ink composition comprising hollow polymer microparticles is jetted on a recording medium such as recording paper, the aqueous medium is removed from the central cavity, leaving a void filled with air. The size of this void is designed to effectively scatter visible light, thereby making it possible to obtain a white image on the recording medium.

U.S. Pat. No. 4,880,465 specifically describes an aqueous ink composition comprising commercial hollow polymer microparticles with an outer size of 500 nm and indicates that opacity is increased by comparison with that of aqueous ink compositions containing non-hollow polymer microparticles with an outer size of 500 nm.

Using hollow polymer microparticle groups having outer sizes of multiple types is also known (JP-A-2003-313481). According to JP-A-2003-313481, using at least two hollow polymer microparticle groups that differ in outer size by 100 nm or more makes it possible to control the hue of white images. More specifically, by varying the mixing ratio of a hollow polymer microparticle group of a small size with an outer size of 320 nm and a hollow polymer microparticle group of a large size with an outer size of 900 nm, the hue, or bluish contribution to the white image, as represented by the b value in the Lab methodology can be varied in a systematic and controllable fashion.

However, the hiding ability of the ink composition described in U.S. Pat. No. 4,880,465 is insufficient. Further, JP-A-2003-313481 does not touch at all on the effect of combining hollow polymer microparticle groups having outer sizes of multiple types on the hiding ability, and when the ink composition described specifically in JP-A-2003-313481 was experimentally checked by the inventors, it was found to have insufficient hiding ability (see the below-described embodiments).

The inventors have conducted a comprehensive research aimed at the improvement of hiding ability in ink compositions using hollow polymer microparticles as a white colorant and have found that hiding ability can be improved by using a plurality of hollow polymer microparticle groups (microparticle subgroups) with a difference in the outer diameter within 100 nm, rather than the combination described in JP-A-2003-313481.

A water base dispersion solution containing hollow polymer microparticle groups is initially prepared and the ink composition can be then prepared from this water base dispersion solution.

The present invention is based on this discovery.

### SUMMARY

Accordingly, the present invention relates to a water base dispersion solution comprising hollow polymer microparticles, wherein the hollow polymer microparticles are composed of a plurality of microparticle subgroups, and the difference in the mean particle size between microparticle subgroups that are mutually adjacent in terms of mean particle size is less than 100 nm.

The present invention also relates to a water base ink composition, and more particularly water base ink composition that is ink for ink jet recording, comprising the water based dispersion solution.

Because the water-base dispersion solution in accordance with the present invention comprises hollow polymer microparticle subgroups having a plurality of mean particle sizes, and an ink composition prepared from the water base dispersion solution comprises hollow polymer microparticle subgroups having a plurality of mean particle sizes, a high hiding ability can be demonstrated.

The water-base dispersion solution in accordance with the present invention comprises hollow polymer microparticles, these hollow polymer microparticles are composed of a plurality of microparticle subgroups, and the difference in the mean particle size between microparticle subgroups that are mutually adjacent in terms of mean particle size is less than 100 nm. Here, the expression “the difference in the mean particle size between microparticle subgroups that are mutually adjacent in terms of mean particle size is less than 100 nm” means that when the microparticle subgroups are arranged in the order of mean particle size thereof, the difference in the mean particle size between the mutually adjacent microparticle subgroups is less than 100 nm.

In the present specification, the particle size or mean particle size means a particle size or mean particle size measured with a particle size distribution measurement device using a laser diffraction scattering method as a measurement principle. A particle size analyzer (for example, “Microtrac UPA”, manufactured by Nikkiso KK) using a dynamic light scattering method (FFT power spectrum method) as a measurement principle can be used as a representative particle size distribution measurement device of a laser scattering type.

The particle size of the hollow polymer microparticles that can be used in the water base dispersion solution in accordance with the present invention is preferably 200 nm to 1200 nm, more preferably 280 nm to 1120 nm. The difference in the mean particle size between the mutually adjacent microparticle subgroups is preferably 30 nm to 90 nm. The water base dispersion solution in accordance with the present invention can be prepared by using a combination of 2 or more types (for example, 2 types, 3 types, 4 types, or 5 types) of hollow polymer microparticle subgroups having different mean particle size that satisfies the above-described condition.

No specific limitation is placed on the method for preparing the hollow polymer microparticles used in accordance with the present invention, and various well-known methods can be used. Examples of such methods are described in the aforementioned U.S. Pat. No. 4,880,465 and JP-A-2003-313481 and also U.S. Pat. Nos. 5,229,209, 4,594,363, 4,427,836, and 4,089,800. Further, there are various types of commercial hollow polymer microparticles. Methods for preparing the hollow polymer microparticles and methods for designing the void size or outer diameter are also publicly known and described in the aforementioned documents. The hollow polymer microparticles are prepared by the usual emulsion polymerization technique and contain usual surfactants. A stable dispersion system in which individual hollow polymer microparticles are dispersed in a water base medium can be also prepared. The dispersion solution thus obtained does not require a comminuting operation or grinding operation that are necessary in the preparation of usual pigment ink composition, has good dispersivity, and can be used, for example, for the preparation of ink compositions for ink jet recording.

Examples of vinyl monomers that can be used for the preparation of hollow polymer microparticles include nonionic monoethylenically unsaturated monomers, and examples of monoethylenically unsaturated monomers include styrene, vinyltoluene, ethylene, vinyl acetate, vinyl chloride, vinylidene chloride, acrylonitrile, (meth)acrylamide, various esters, for example, (C₁-C₂₀) alkyl or (C₃-C₂₀) alkenyl esters of (meth)acrylic acid, such as methyl acrylate (MA), methyl methacrylate (MMA), ethyl acrylate (EA) and butyl acrylate (BA). Examples of (meth)acrylic acid esters include acrylates such as methyl methacrylate (MMA), methyl acrylate (MA), ethyl (meth)acrylate (EMA), butyl(meth)acrylate (BMA), 2-hydroxyethylmethacrylate (HEMA), 2-ethylhexyl(meth)acrylate (EHMA), benzyl(meth)acrylate, lauryl(meth)acrylate, oleyl(meth)acrylate, palmityl(meth)acrylate, and stearyl(meth)acrylate.

The outer shell (polymer membrane) can be formed by copolymerization and cross linking of difunctional vinyl monomers, such as divinyl benzene, allyl methacrylate, ethylene glycol dimethacrylate, 1,3-butane-diol dimethacrylate, diethylene glycol dimethacrylate, and trimethylol propane trimethacrylate.

A dispersion medium for hollow polymer microparticles used in accordance with the present invention is a water base dispersion medium, for example, water or water containing a hydrophilic organic solvent. Examples of surfactants used during emulsion polymerization include anionic surfactants, nonionic surfactants, cationic surfactants, amphoteric surfactants, or organic suspension protective agents.

No specific limitation is placed on the content (solids) of hollow polymer microparticles in the water base dispersion solution in accordance with the present invention. For example, this content is preferably 10 to 90 wt. %, more preferably 20 to 80 wt. % based on the total weight of the water base dispersion solution. No specific limitation is also placed on the mixing ratio of individual hollow polymer microparticle subgroups contained in the water base dispersion solution in accordance with the present invention, provided that the ink composition prepared from this water base dispersion solution can demonstrate good hiding ability. When 2 or more hollow polymer microparticle subgroups are mixed, the content of solids of each hollow polymer microparticle subgroup may be at least 5 wt. % based on the total content of solids of the mixed hollow polymer microparticles.

The ink composition in accordance with the present invention can be prepared by well-known methods from the water base dispersion solution. The ink composition in accordance with the present invention can contain well-known additives of various types in addition to the hollow polymer microparticles and aqueous dispersion medium. The usual additives that are contained in the usual ink compositions can be used. For example, when an ink composition for ink jet recording is prepared, additives that have been usually used for the preparation of ink compositions for ink jet recording can be used.

No specific limitation is placed on the content ratio of the hollow polymer microparticles in the ink composition in accordance with the present invention, provided that good hiding ability is demonstrated. For example, this content is preferably 50 to 90 wt. %, more preferably 10 to 80 wt. % based on the total weight of the ink composition. The mixing ratio of the individual hollow polymer microparticle subgroups contained in the ink composition in accordance with the present invention is the same as the mixing ratio in the water base dispersion solution.

The ink composition in accordance with the present invention can be applied as a white ink on any recording substrate. Examples of recording substrates include paper, thick paper, fiber products (for example, fabrics), natural or synthetic sheets or films, or plastics, glass, and ceramics. The ink composition in accordance with the present invention can be applied to any printing system. For example, it can be used with various printing devices such as a thermal ink jet printer, a piezoelectric ink jet printer, a continuous ink jet printer, a roller applicator, or a spray applicator.

### DESCRIPTION OF EXEMPLARY EMBODIMENTS

The present invention will be described below in greater detail based on embodiments and comparative examples, but the present invention is not limited to these embodiments. Parts and % in the embodiments and comparative examples below stand for parts by weight and wt. %, unless stated otherwise.

Method for Manufacturing Hollow Polymer Microparticle Emulsion

(1) Polymer Particles 1

A total of 80 parts of styrene, 5 parts of methacrylic acid, 15 parts of methyl methacrylate, 1 part of α-methyl styrene dimer, 14 parts of t-dodecyl mercaptan, 0.8 part of sodium dodecyl benzene sulfonate, 1.0 part of potassium sulfite, and 200 parts of water were charged into a 2 L reaction container, and emulsion polymerization was conducted for 6 h by heating to 80° C. under stirring in nitrogen gas. The polymer particles 1 thus obtained had a mean particle size of 0.15 μm.

(2) Hollow Polymer Microparticle Emulsion 1

A total of 10 parts (calculated as solids) of polymer particles 1 obtained in clause (1) and also 0.3 part of sodium lauryl sulfate, 0.5 part of potassium sulfite, and 400 parts of water were charged into a reaction container, then a cross-polymerizable monomer composition based on a mixture of 11.6 parts of divinyl benzene (purity 55 wt. %, remainder is a monofunctional vinyl monomer), 8.4 parts of ethylvinyl benzene, 5 parts of acrylic acid, and 75 parts of methyl methacrylate was added, stirring was conducted for 1 h at 30° C., and then a water base dispersion solution was obtained by conducting emulsion polymerization, while stirring for 5 h at 70° C. A particle size in the solution that was measured with a particle size analyzer (“Microtrac UPA”, manufactured by Nikkiso KK) was 320 nm. Separately performed observations under a transmitting electron microscope demonstrated that the particles were hollow polymer microparticles. The emulsion thus obtained will be referred to as a hollow polymer microparticle emulsion 1.

(3) Hollow Polymer Microparticle Emulsions 2 to 5 and 7

Hollow polymer microparticle emulsions 2 to 5 and 7 were obtained in the same manner as the “hollow polymer microparticle emulsion 1” of clause (1), except that the polymer particles 1 to 5 obtained from the compositions shown in Table 1 and the compositions shown in Table 2 were used.

(4) Hollow Polymer Microparticle Emulsion 6

A total of 2 parts of polymer particles 1, 20 parts of poly(vinyl alcohol), 2 parts of 3,5,5-trimethylhexanoyl peroxide as a polymerization initiator, and 500 parts of water were charged into a reaction container, a mixture of 400 parts of toluene and a cross-polymerizable monomer composition comprising a mixture of 25 parts of ethylene dimethacrylate, 5 parts of methacrylic acid, and 70 parts of methyl methacrylate was then added into the container and stirring was conduced for 2 h at 40° C. Then, emulsion polymerization was conducted, while stirring for 15 h at 70° C., and a water base dispersion solution was obtained. The emulsion thus obtained will be referred to as a hollow polymer microparticle emulsion 6.

TABLE 1

| | Polymer particles | | | | |
|---|---|---|---|---|---|
| Composition (parts) | 1 | 2 | 3 | 4 | 5 |
| Styrene | 80 | 80 | 80 | 100 | 80 |
| Methyl methacrylate | 15 | 15 | 7 | | 15 |
| Methacrylic acid | 5 | 5 | | | |
| Acrylonitrile | | | 8 | | |
| Acrylic acid | | | 5 | | 5 |
| α-Methyl styrene dimer | 1 | 2 | 1 | 1 | |
| Mean particle size (nm) | 150 | 200 | 550 | 250 | 300 |

TABLE 2

| | | Hollow polymer microparticles emulsion | | | | | | |
|---|---|---|---|---|---|---|---|---|
| | | 1 | 2 | 3 | 4 | 5 | 6 | 7 |
| Polymer | Type | 1 | 2 | 1 | 4 | 5 | 1 | 3 |
| particles | Amount used (parts) | 10 | 10 | 5 | 10 | 10 | 2 | 10 |
| Monomer | Divinyl benzene | 11.6 | 11.6 | 11.6 | 11.6 | 11.6 | | 11.6 |
| | Ethylene | | | | | | 25 | |
| | glycol dimethacrylate | | | | | | | |
| | Styrene | 5 | 5 | 5 | | | | 5 |
| | Ethylvinyl benzene | 8.4 | 8.4 | 8.4 | 8.4 | 8.4 | | 8.4 |
| | Acrylic acid | 5 | | 5 | | 5 | | |
| | Methacrylic acid | | 5 | | 5 | | 5 | 5 |
| | Methyl | 75 | 75 | 75 | 75 | 75 | 70 | 75 |
| | methacrylate | | | | | | | |

| | | | | | | | |
|---|---|---|---|---|---|---|---|
| Particle size | 320 | 400 | 460 | 520 | 840 | 920 | 1000 |

Each water base dispersion solution was adjusted to a content of solids of 25%, and as described below, ink compositions 1 to 5 in accordance with the present invention (Embodiments 1 to 5) and ink compositions 1 to 2 for comparison (Comparative Examples 1 to 2) were produced by using various combinations of the obtained hollow polymer microparticle emulsions.

### Embodiment 1

| | |
|---|---|
| Hollow polymer microparticle emulsion 1 | 26 wt. % |
| (particle size: 320 nm, solids 25.0%) | |
| Hollow polymer microparticle emulsion 2 | 27 wt. % |
| (particle size: 400 nm, solids 25.0%) | |
| Hollow polymer microparticle emulsion 3 | 27 wt. % |
| (particle size: 460 nm, solids 25.0%) | |
| Glycerin | 10 wt. % |
| BYK348 | 0.3 wt. % |
| (BYK Chemie Japan Co., Ltd., silicone base surfactant) | |
| Triethanolamine | 0.9 wt. % |
| Pure water | balance |

### Embodiment 2

| | |
|---|---|
| Hollow polymer microparticle emulsion 2 | 26 wt. % |
| (particle size: 400 nm, solids 25.0%) | |
| Hollow polymer microparticle emulsion 3 | 27 wt. % |
| (particle size: 460 nm, solids 25.0%) | |
| Hollow polymer microparticle emulsion 4 | 27 wt. % |
| (particle size: 520 nm, solids 25.0%) | |
| Glycerin | 10 wt. % |
| BYK348 | 0.3 wt. % |
| (BYK Chemie Japan Co., Ltd., silicone base surfactant) | |
| Triethanolamine | 0.9 wt. % |
| Pure water | balance |

### Embodiment 3

| | |
|---|---|
| Hollow polymer microparticle emulsion 1 | 20 wt. % |
| (particle size: 320 nm, solids 25.0%) | |
| Hollow polymer microparticle emulsion 2 | 20 wt. % |
| (particle size: 400 nm, solids 25.0%) | |
| Hollow polymer microparticle emulsion 3 | 20 wt. % |
| (particle size: 460 nm, solids 25.0%) | |
| Hollow polymer microparticle emulsion 4 | 20 wt. % |
| (particle size: 520 nm, solids 25.0%) | |
| Glycerin | 10 wt. % |
| BYK348 | 0.3 wt. % |
| (BYK Chemie Japan Co., Ltd., silicone base surfactant) | |
| Triethanolamine | 0.9 wt. % |
| Pure water | balance |

### Embodiment 4

| | |
|---|---|
| Hollow polymer microparticle emulsion 6 | 40 wt. % |
| (particle size: 920 nm, solids 25.0%) | |
| Hollow polymer microparticle emulsion 7 | 40 wt. % |
| (particle size: 1000 nm, solids 25.0%) | |
| Glycerin | 10 wt. % |
| BYK348 | 0.3 wt. % |
| (BYK Chemie Japan Co., Ltd., silicone base surfactant) | |
| Triethanolamine | 0.9 wt. % |
| Pure water | balance |

### Embodiment 5

| | |
|---|---|
| Hollow polymer microparticle emulsion 5 | 26 wt. % |
| (particle size: 840 nm, solids 25.0%) | |
| Hollow polymer microparticle emulsion 6 | 27 wt. % |
| (particle size: 920 nm, solids 25.0%) | |
| Hollow polymer microparticle emulsion 7 | 27 wt. % |
| (particle size: 1000 nm, solids 25.0%) | |
| Glycerin | 10 wt. % |
| BYK348 | 0.3 wt. % |
| (BYK Chemie Japan Co., Ltd., silicone base surfactant) | |
| Triethanolamine | 0.9 wt. % |
| Pure water | balance |

### Comparative Example 1

| | |
|---|---|
| Hollow polymer microparticle emulsion 1 | 40 wt. % |
| (particle size: 320 nm, solids 25.0%) | |
| Hollow polymer microparticle emulsion 6 | 40 wt. % |
| (particle size: 920 nm, solids 25.0%) | |
| Glycerin | 10 wt. % |
| BYK348 | 0.3 wt. % |
| (BYK Chemie Japan Co., Ltd., silicone base surfactant) | |
| Triethanolamine | 0.9 wt. % |
| Pure water | balance |

### Comparative Example 2

| | |
|---|---|
| Hollow polymer microparticle emulsion 3 | 40 wt. % |
| (particle size: 460 nm, solids 25.0%) | |
| Hollow polymer microparticle emulsion 6 | 40 wt. % |
| (particle size: 920 nm, solids 25.0%) | |
| Glycerin | 10 wt. % |
| BYK348 | 0.3 wt. % |
| (BYK Chemie Japan Co., Ltd., silicone base surfactant) | |
| Triethanolamine | 0.9 wt. % |
| Pure water | balance |

Evaluation of Hiding Ability

Black monochromatic solid printing was performed with an ink jet printer (PX-A550, manufactured by Seiko-Epson Co., Ltd.). Separately therefrom, the 7 ink compositions prepared in Embodiments 1 to 5 and Comparative Examples 1 to 2 were printed with the same ink jet printer (PX-A550) on OHP sheets (EPSON special paper, manufactured by Seiko-Epson Co., Ltd,), the white-printed OHP sheets were placed on black-printed photomate paper, and a Db value (Density of black; OD value) and L*a*b* values were measured. Gretag Macbeth SPM 50 (manufactured by Gretag Macbeth Co., Ltd.) was used as the measurement device. The measurement results are shown in Table 3. The reference example represents measurement values obtained with the black-printed photomate paper, without placing the white-printed OHP sheet.

TABLE 3

| | Db | L* | a* | b* |
|---|---|---|---|---|
| Embodiment 1 | 0.37 | 74.2 | −3.01 | −7.66 |
| Embodiment 2 | 0.32 | 75.22 | −2.65 | −6.8 |
| Embodiment 3 | 0.29 | 77.48 | −1.51 | −4.62 |
| Embodiment 4 | 0.26 | 80.66 | −2.39 | −6.32 |
| Embodiment 5 | 0.16 | 88.03 | −1.76 | −4.18 |
| Comparative Example 1 | 0.45 | 70.91 | −5.2 | −12.47 |
| Comparative Example 2 | 0.42 | 68.15 | −0.49 | −3.84 |
| Reference example (Black only) | 1.96 | 9.56 | −0.63 | −3.26 |

Because the base dispersion solution in accordance with the present invention comprises hollow polymer microparticles, the solution is suitable for the preparation of white ink composition. In particular, because the water base dispersion solution is prepared by combining hollow polymer microparticle subgroups having a plurality of mean particle sizes, the solution is suitable for the preparation of a white ink composition having a high hiding ability.

Because the ink composition in accordance with the present invention comprises hollow polymer microparticles, it can be used as white ink composition. In particular because the ink composition comprises a combination of hollow polymer microparticle subgroups having a plurality of mean particle sizes, it can be advantageously used for applications requiring a high hiding ability.

What is claimed is:

1. A water base dispersion solution comprising hollow polymer microparticles, wherein the hollow polymer microparticles are composed of a plurality of microparticle subgroups, and the difference in the mean particle size between microparticle subgroups that are mutually adjacent in terms of mean particle size is less than 100 nm.

2. A water base ink composition comprising the water base dispersion solution described in claim 1.
